(19) United States
(12) Patent Application Publication
(10) Pub. No.: US 2024/0205833 A1
(43) Pub. Date: Jun. 20, 2024

(54) Electric Device with a Communication Module

(71) Applicant: Robert Bosch GmbH, Stuttgart (DE)

(72) Inventors: Thilo Schulz, Kirchheim (DE); Tobias Kuhlmann, Stuttgart (DE)

(21) Appl. No.: 18/534,849

(22) Filed: Dec. 11, 2023

(30) Foreign Application Priority Data
Dec. 15, 2022 (DE) 10 2022 213 721.3

(51) Int. Cl. H04W 52/02

(52) U.S. Cl. CPC H04W 52/0254; H04W 52/0283

(57) ABSTRACT

An electric device, in particular an electric bicycle, includes an electronic system having a control unit and a first communication interface for wireless communication. The electric device also includes a communication module having a second communication interface. The electric device is configured to exchange data or information with a mobile terminal. The communication module is configured to be deactivated by the mobile terminal.

This application claims priority under 35 U.S.C. § 119 to patent application no. DE 10 2022 213 721.3, filed on Dec. 15, 2022 in Germany, the disclosure of which is incorporated herein by reference in its entirety.

### BACKGROUND

Electric devices, including electric bicycles are known. Additional control of electric devices is desired.

### SUMMARY

The disclosure relates to an electric device, in particular an electric bicycle, having an electronic system comprising a control unit, wherein the electronic system has a first communication interface for wireless communication, wherein the electric device has a communication module, wherein the communication module has a second communication interface, wherein the electric device is configured to exchange data or information with a mobile terminal. It is proposed that the communication module is configured such that it can be deactivated by the mobile terminal. Advantageously, transport of the communication module can be improved thereby.

The electric device is preferably configured as a battery operated electric device. In particular, the electric device comprises at least one replaceable energy storage unit, which is preferably configured to be releasable from a housing of the electric device without tools. For example, the electric device may be configured as an electric bicycle, as a hand-held power tool, as a household appliance, as a garden tool, or the like.

In the context of this application, an electric bicycle should in particular be understood as a bicycle that has a drive unit for assisting the driver. The electric bicycle is preferably configured as an e-bike, a pedelec, a cargo bicycle, a folding bicycle, or the like. The drive unit has a motor, which can be configured as a mid-drive motor, for example, or as a hub motor. The motor is preferably configured as an electric motor. The drive unit is connected to a power supply device for supplying power to the drive unit. The power supply unit is preferably configured as a battery pack and comprises a battery housing, which is preferably releasably connected to a frame of the bike. The electric bike comprises an electronic system comprising a control unit for controlling or regulating the electric bike. The electronic system preferably comprises a sensor unit, wherein the sensor unit can have, for example, motion sensors, torque sensors, speed sensors, GPS sensors, magnetic sensors, or the like. In addition, the electronic system comprises at least one communication interface for wirelessly connecting the electric bicycle to the control device and/or the server.

The mobile terminal may be configured, for example, as a laptop, a smartphone, a tablet, or a smartwatch. The mobile terminal comprises at least one communication interface corresponding to the first communication interface and/or the second communication interface of the electric device. The mobile terminal can be connected to the electric device, such that operating information of the electric device is available to the mobile terminal and/or control of the electric device is possible by the mobile terminal. The operating information of the electric bicycle may be, for example, a speed of the electric bicycle, a distance traveled by the electric bicycle, a current position of the electric bicycle, a charging state of a battery pack of the electric bicycle, or the like. Control of the electric bicycle may be configured, for example, to switch a drive unit of the electric bicycle on or off, to set an assistance mode of the drive unit, etc.

The first and second communication interfaces are preferably configured as different communication interfaces. The communication interfaces can be configured, for example, as a Bluetooth interface, BLE interface, WiFi interface, Zigbee interface, mobile telephone interface, satellite interface, etc.

In the context of this application, deactivating the communication module should at least be understood to mean that the second communication interface of the communication module is deactivated, such that data is no longer received or transmitted via the second communication interface. In particular, substantially all electronic components of the communication module are not powered in the deactivated state. Alternatively, it is also conceivable that the electrical components are only partially deactivated, for example only the electronic components emitting a radio signal. The communication module may be configured such that it can be connected to an energy store of the electric device for the power supply and/or may have a separate power supply.

Furthermore, it is proposed that the communication module is configured so that it can be deactivated, in particular only by the first communication interface. Advantageously, the safety of the system can thereby be increased.

Furthermore, it is proposed that the communication module is configured such that it can be deactivated by the second communication interface. Advantageously, deactivation can thus also be enabled from a greater distance to the electric device.

In addition, it is proposed that the communication module is in particular configured such that it can only be activated by the mobile terminal. Advantageously, safety can be further improved thereby. Preferably, the mobile terminal is configured as an authenticated terminal that is assigned to a user ID by itself or by means of application software, wherein the user ID has an authorization for deactivation.

Furthermore, it is proposed that the mobile terminal is configured so that it can be connected to the electric device via the first communication interface, such that the mobile terminal is configured as a control device for the electric device. Advantageously, control of the electric device can be improved thereby.

It is further proposed that the communication module has a position sensor, in particular a GNSS receiver. Advantageously, precise localization of the electric device connected to the communication module can be ensured thereby.

It is also proposed that the communication module has a motion sensor, in particular an acceleration sensor. Advantageously, movements and vibrations of the electric device can be detected thereby.

Furthermore, it is proposed that the communication module is configured as a monitoring unit. The monitoring unit is preferably configured to monitor the position and/or movement of the electric device.

It is further proposed that the communication module is configured so that it can be electrically connected to the electronic system of the electric device. Advantageously, the sensors and/or the communication options of the electric device can be supplemented and/or extended as a result. The connection can be wired, for example, via a cable, or wireless, for example using a short-range communication interface.

It is also proposed that the communication module is configured as an optional component of the electric device, in particular as an accessory. Advantageously, the communication module can also be retrofitted thereby. The communication module may be configured to be accessible from the outside or integrated in a housing of the electric device. The communication module may be releasable from the electric device without tools or may be releasable from the electric device using tools.

Furthermore, it is proposed that the first communication interface is configured as a short-range communication interface, in particular a Bluetooth interface, and the second communication interface is configured as a long-range communication interface, in particular a mobile telephone interface. Advantageously, an optimum provision of data can thus be ensured. The first communication interface is in particular configured to connect directly to the mobile terminal. The second communication interface is in particular configured for indirect connection to the mobile terminal, wherein the connection is via at least one further device, in particular a radio mast.

### BRIEF DESCRIPTION OF THE DRAWINGS

Further advantages follow from the description of the drawings hereinafter. The drawings, the description, and the claims contain numerous features in combination. The person skilled in the art will appropriately also consider the features individually and combine them to form further meaningful combinations. Shown are:

FIG. 1 a schematic view of a system comprising an electric device and a mobile terminal; and

FIG. 2 a schematic flow chart showing a method for deactivating a communication module of the electric device.

### DETAILED DESCRIPTION

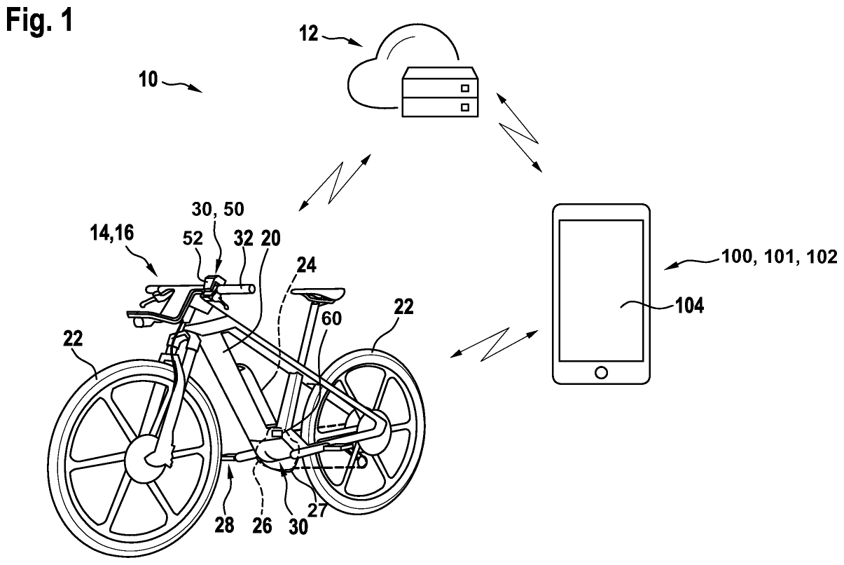

In FIG. 1, a system 10 comprising a server 12, an electric device 14, and a mobile terminal 100 is shown in a schematic view.

The electric device 14 is configured, e.g., as an electric bicycle 16. The electric bicycle 16 can be configured, for example, as a pedelec or an e-bike.

The mobile terminal 100 is configured, e.g., as a control device 101 for the electric device 14. The mobile terminal 100 is also configured, e.g., as a smartphone. In particular, the mobile terminal 100 has an operating system configured to execute various application software. Preferably, the mobile terminal 100 has at least one application software configured to display operating information of the electric bicycle 16 and/or to control the electric bicycle 16, for example, a cycling app.

The electric bike 16 has a housing in the form of a frame 20 and/or a bike frame. Connected to the frame 20 are two wheels 22. In addition, the electric bike 16 has a power supply unit 24 in the form of a battery pack. The battery pack is configured, e.g., as a rechargeable battery pack releasably connected to the electric bicycle 16 without tools. In addition, the electric bicycle 16 has a drive unit 26, which comprises an electric motor and/or an auxiliary motor. The electric motor is preferably configured as a permanent magnet-excited, brushless DC motor. The electric motor is configured, e.g., as a mid-drive motor, wherein a hub motor or the like is also conceivable. The electric bike 16, in particular the drive unit 26 of the electric bike 16, is powered via the power supply unit 24. The power supply unit 24 can be externally mountable to the frame 20 or can be integrated into the frame 20.

The electric bicycle 16 comprises an electronic system having a control unit, which is configured to control or regulate the electric bicycle 16, in particular the electric motor. The electric bike 16 has a pedal crank 28. The pedal crank 28 has a pedal crankshaft (not shown).

The drive unit 26 having the electric motor and the pedal crankshaft are arranged within a drive housing 27 connected to the frame 20. The drive movement of the electric motor is preferably transmitted to the pedal crankshaft via a transmission (not shown), wherein the magnitude of the assistance by the drive unit 26 is controlled or regulated via the control unit. The control unit is configured to drive the drive unit, such that the driver of the electric bike 16 is assisted in pedaling. Preferably, the control unit is configured such that it can be operated by the driver so that the driver can set the assistance level. The electric bicycle 16 has, for example, a light assistance mode and a strong assistance mode, wherein the drive unit provides greater assistance for the driver in the strong assistance mode.

The electronic system comprises, e.g., a control module 50 arranged on a handlebar 32 of the electric bike 16. Alternatively, positioning, e.g., within the frame 20, is also conceivable, preferably in an upper tube of the frame 20. The control module 50 comprises, e.g., a housing 52 in which a computing unit (not shown), a memory unit (not shown), and a first wireless communication interface (not shown) is arranged. The control module 50 is, e.g., connected to further electric bicycle components, in particular the battery pack 24 and the power unit 26, via at least one cable (not shown). The cables are preferably hidden within the frame 20. Alternatively or additionally, a wireless connection via the communication interface of the control module 50 is also conceivable. Bicycle- and/or user-specific information may be stored in the memory unit of the electronic system. Information regarding the installed bicycle components, a bicycle ID, and user information in the form of preferred locations of use of the electric bicycle 16 are stored, e.g., in the memory unit.

The first communication interface is configured, e.g., as a short-range communication interface, in particular in the form of a BLE (Bluetooth Low Energy) interface. The electric bicycle 16 is configured to be connected directly to the mobile terminal 100 for exchanging data via the first communication interface of the control module 50.

In addition, the electric device 14 comprises a communication module 60. The communication module 60 is arranged, e.g., in the drive housing 27 of electric bicycle 16, wherein other positions in or on the housing of electric device 14 are conceivable. The communication module 60 comprises a housing (not shown) in which electronic components of the communication module 60 are housed. The communication module 60 comprises a second wireless communication interface. The second communication interface is configured, e.g., as a long-range communication interface, in particular as a mobile telephone interface, preferably as an LTE, preferably CAT M1 or NB-IoT, or 5G interface. The communication module 60 is electrically connected to the electric device 14, in particular the electronic system and battery pack. Advantageously, the first communication interface may enable data exchange between the electric device 14 and mobile terminals 100 in the immediate vicinity of the electric device 14, and may enable data exchange with a server or a cloud via the second communication interface. The communication module 60 is preferably configured as an optional bicycle component or accessory, such that the electric bicycle 16 may also operate without the communication module 60. The communication module 60 is associated, e.g., with the electronic system of the electric bicycle 16 in the connected state, such that the control unit can access and use the electronic components or the functions of the communication module 60. Alternatively, it is also conceivable that the communication module 60 may not be connected to the electronic system of the electric device 14.

The communication module 60 further comprises a position sensor, e.g., in the form of a GNSS receiver. Advantageously, the position of the electric bicycle 16 can thereby be detected. In addition, the communication module comprises at least one motion sensor in the form of an acceleration sensor. In particular, the communication module 60 is configured as a monitoring unit, such that the communication module 60 can, in particular independently of the electronic system of the electric device 14, determine whether there is movement of the electric device 14 and, in the event of impermissible movement, provide the movement and position to a server to provide the information to a user.

In addition, the electric bicycle 16 comprises an operating unit 30 for operating the electric bicycle 16. The operating unit 30 is arranged on the handlebar 32 of the electric bicycle 16. The operating unit 30 is formed, e.g., by the control module 50. The operating unit 30 has, e.g., an on/off switch not shown in detail, wherein the electric bicycle 16, in particular the drive unit 26, is configured to be activated by actuating the switch. In addition, the electronic system is configured to be controllable by means of the operating unit 30, for example a selection of an assistance mode of the electric bicycle 16 is possible by means of an operation of the operating unit 30.

The control device 101 is configured, e.g., as a smartphone 102. The control device 101 comprises a display unit 104 that is configured to display information. The display unit 104 is configured, e.g., as a touchscreen, such that the control device 101 can be operated and/or controlled by actuating or touching the display unit 104.

The control device 101 has at least one cycling app configured to display operating information of the electric bicycle 16 and/or control the electric bicycle 16.

The control device 101 has at least one short-range communication interface corresponding to the first communication interface of the electric bicycle 16. The short-range communication interface is configured, e.g., as a Bluetooth interface. The control device 101 may establish a connection to the electric bicycle 16 depending on or independent of the cycling app. This connection is made, e.g., via a Bluetooth pairing process. The pairing process couples and connects the control device 101 and the electric bike 16 to each other. If the control device 101 is physically disconnected from the electric bicycle 16, wireless communication is also disconnected via the first communication interface, but they remain in the coupled state.

In addition, the control device 101 comprises at least one long-range communication interface for wireless communication with the server 12 and the second communication interface of communication module 60 of the electric bicycle 16. The long-range communication interface is, e.g., configured as a 5G interface.

The cycling app installed on the mobile terminal 100 comprises, e.g., a deactivation function for the communication module 60 of the electric bicycle 16. When a user of the cycling app actuates the deactivation function, the communication module 60 is activated, such that all the sensors and the second communication interface are switched off and therefore no data can be detected, transmitted, or received. Advantageously, this can ensure safe transport in sensitive environments or prevent malfunctions associated with the data of the communication module 60.

The electric device 14 is configured, e.g., such that activation and/or deactivation of the communication module 60 by a user is not carried out by the electric device 14 or the control unit of the electric device 14 alone, but only by a mobile terminal connected wirelessly to the electric bicycle 16. Advantageously, unintentional intervention in the functions provided by the communication module 60 can be prevented thereby.

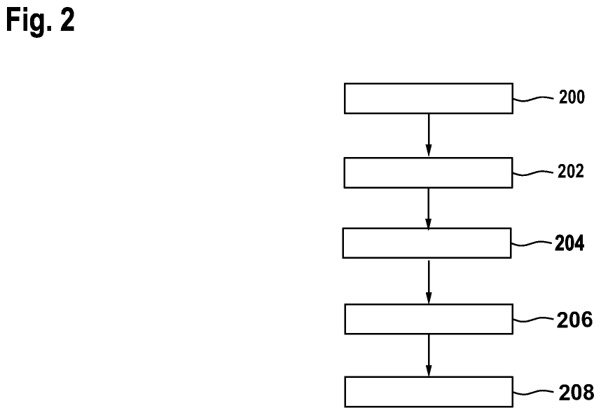

In FIG. 2, a flow chart with an exemplary method for deactivating the communication module 60 is shown.

In a first step 200, the communication module 60 is connected to the electronic system of electric bicycle 16. In the connected state, data may be transmitted and/or received between the communication module 60 and the electronic system of the electric bicycle 16 on one or both sides. The connection is made, e.g., via a cable connection.

In a second step 202, the mobile terminal 100 is coupled and connected to the electric bicycle 16 by means of the first communication interface of the electric bicycle 16. The coupling is carried out, e.g., via a pairing process, wherein the devices are known to each other in the coupled state and data can be exchanged in the connected state.

In a further step 204, a bicycle app provided for the electric bicycle 16 is installed in the coupled or connected state. The bicycle app can be used to display operating information of the electric device 14 on the mobile terminal 100 during use of the electric device 14, for example a current speed or navigation information. In addition, functions of the electric bicycle 16, for example an assistance mode of the electric bicycle 16, can also be set by the cycling app.

In a further step 206, a monitoring function is activated in the cycling app. If the monitoring function is activated, the data of the first communication module 60, in particular movement data and position data, are detected and, depending on their relevance, sent directly to the server 12 via the communication module 60 and without the mobile terminal 100.

In a further step 208, the communication module 60 is deactivated by the mobile terminal 100, in particular by the cycling app installed on the mobile terminal 100. In the deactivated state, no data are sent directly to the server by the electric bicycle 16.

To activate the communication module 60, an activation command can be provided by the mobile terminal 100 via the first communication interface of the electric bicycle 16, whereby the control unit of the electric bicycle 16 activates the communication module, in particular the second communication interface, the motion sensor, and the GNSS receiver.

What is claimed is:

1. An electric device, comprising:
an electronic system including a control unit and a first communication interface for wireless communication; and
a communication module including a second communication interface,
wherein the electric device is configured to exchange data or information with a mobile terminal, and
wherein the communication module is configured to be deactivated by the mobile terminal.

2. The electric device according to claim 1, wherein the communication module is only configured to be deactivated by the first communication interface.

3. The electric device according to claim 1, wherein the communication module is configured to be deactivated by the second communication interface.

4. The electric device according to claim 1, wherein the communication module is configured to be activated by the mobile terminal.

5. The electric device according to claim 1, wherein the mobile terminal is configured to be connected to the electric device by the first communication interface, such that the mobile terminal is configured as a control device for the electric device.

6. The electric device according to claim 1, wherein the communication module has a position sensor including a GNSS receiver.

7. The electric device according to claim 1, wherein the communication module has a motion sensor including an acceleration sensor.

8. The electric device according to claim 1, wherein the communication module is configured as a monitoring unit.

9. The electric device according to claim 1, wherein the communication module is electrically connected to the electronic system.

10. The electric device according to claim 1, wherein the communication module is configured as an optional component of the electric device.

11. The electric device according to claim 1, wherein:
the first communication interface is configured as a short-range communication interface, and
the second communication interface is configured as a long-range communication interface.

12. The electric device according to claim 11, wherein:
the short-range communication interface is a Bluetooth interface, and
the long-range communication interface is a mobile telephone interface.
